(19) United States
(12) Patent Application Publication
(10) Pub. No.: US 2025/0146586 A1
(43) Pub. Date: May 8, 2025

(54) PRESSURE RELIEF VALVE DEVICE

(71) Applicant: WINNER HYDRAULICS CORPORATION, Hua-Tan Hsiang (TW)

(72) Inventor: Wu-Long SUNG, Hua-Tan Hsiang (TW)

(21) Appl. No.: 18/594,550

(22) Filed: Mar. 4, 2024

(30) Foreign Application Priority Data
Nov. 3, 2023 (TW) 112142481

(51) Int. Cl. F16K 17/04; F16K 17/06

(52) U.S. Cl. CPC F16K 17/048; F16K 17/06

(57) ABSTRACT

A pressure relief valve device includes a valve housing defining a chamber, a sleeve having a peripheral wall defining a pressure relief hole, and a plurality of inlet holes in fluid communication with the pressure relief hole, a pushed unit including a pushed rod, a flow guiding passage, and a valve cover, and a biasing member biasing the valve cover toward the pushed rod. The pushed rod is disposed movably in the sleeve, and blocks fluid communication among the inlet holes and the pressure relief hole when being pushed by a fluid in the pressure relief hole. The flow guiding passage extends through the pushed rod and is in fluid communication with the pressure relief hole. The valve cover is movable relative to the pushed rod between closed and pressure relief positions, where fluid communication between the flow guiding passage and the chamber is allowed and prevented, respectively.

### CROSS-REFERENCE TO RELATED APPLICATION

This application claims priority to Taiwanese Invention Patent Application No. 112142481, filed on Nov. 3, 2023, and incorporated by reference herein in its entirety.

### FIELD

The disclosure relates to a valve device, and more particularly to a pressure relief valve device.

### BACKGROUND

Referring to FIGS. 1 and 2, a conventional pressure relief valve includes a housing 91, a sleeve 92 connected to one end of the housing 91, an end plug 93 connected to another end of the housing 91, a pushed rod 94 disposed in the sleeve 92 and the housing 91 and movable along an axis (X), an abutment member 95 connected fixedly to an end of the pushed rod 94, an adjusting rod 96 extending through the end plug 93 into the housing 91 and movable along the axis (X), and a biasing member 97 disposed in the housing 91 and disposed between and abutting against the abutment member 95 and the adjusting rod 96. The housing 91 defines first and second chambers 911, 912 spaced-apart along the axis (X), and includes a connection passage 913 disposed between and in spatial communication with the first and second chambers 911, 912. A portion of the sleeve 92 is disposed in the first chamber 911 and engages threadedly the housing 91. The sleeve 92 has a peripheral wall 921 surrounding the axis (X), a plurality of through holes 922 extending transversely to the axis (X) and formed through the peripheral wall 921, and a blocking shoulder 923 extending inwardly from an inner surface of the peripheral wall 921 and surrounding the axis (X). The peripheral wall 921 defines a pressure relief hole 924 in fluid communication with the through holes 922. The through holes 922 are in fluid communication with a first oil tank (not shown). The blocking shoulder 923 is disposed between the through holes 922 and the pressure relief hole 924. The pressure relief hole 924 are in fluid communication with a second oil tank (not shown). The pushed rod 94 is pushed by a fluid in the pressure relief hole 924 to move relative to the sleeve 92 along the axis (X). The pushed rod 94 has a blocking inclined surface 941 operable to abut against the blocking shoulder 923 to block the fluid communication among the through holes 922 and the pressure relief hole 924. The abutment member 95 is disposed in the connection passage 913, is driven by the pushed rod 94 to move along the axis (X), and has a first abutment end 951 disposed in the first chamber 911, and a second abutment end 952 disposed in the second chamber 912 and abutting against one end of the biasing member 97. The end plug 93 is fixed to said another end of the housing 91 that is opposite to the sleeve 92. The adjusting rod 96 is rotatable relative to and threadedly engages the end plug 93, and has a portion extending into the second chamber 912 and abutting against another end of the biasing member 97 that is opposite to the abutment member 95. The biasing member 97 has a biasing force exerting on the abutment member 95 and being adjustable as a result of rotation and movement of the adjusting rod 96 relative to the end plug 93.

The pushed rod 94 is movable relative to the sleeve 92 between a communication position and a closed position. As shown in FIG. 1, when the pushed rod 94 is at the communication position, the second abutment end 952 of the abutment member 95 is pushed by the biasing member 97 toward the sleeve 92, the first abutment end 951 abuts against the sleeve 92, and the blocking inclined surface 941 of the pushed rod 94 is spaced apart from the blocking shoulder 923 such that the through holes 922 are in fluid communication with the pressure relief hole 924. At this position, a fluid in the first oil tank flows through the through holes 922 into the pressure relief hole 924 and then flows into the second oil tank to decrease a pressure in the first oil tank.

Referring to FIG. 2, when a force exerted on the pushed rod 94 by the fluid in the pressure relief hole 924 and the second oil tank is larger than the biasing force of the biasing member 97, the pushed rod 94 and the abutment member 95 are moved relative to the sleeve 92 to compress the biasing member 97, the first abutment end 951 is moved away from the sleeve 92 along the axis (X), and the blocking inclined surface 941 abuts against the blocking shoulder 923 such that the pushed rod 94 is moved to the closed position to block the fluid communication among the through holes 922 and the pressure relief hole 924.

However, in a case where the second oil tank is a closed tank, a pressure of the fluid in the second oil tank increases when an ambient temperature rises, which may damage the second oil tank and result in leakage. Additionally, the blocking inclined surface 941 and the blocking shoulder 923 may be worn after a time period of use and thus may be unable to provide a seal among the through holes 922 and the pressure relief hole 924. Consequently, a portion of the fluid from the through holes 922 flows into the pressure relief hole 924 when the pushed rod 94 is at the closed position, and the pressure of the fluid in the second oil tank undesirably rises and is eventually the same as a pressure of the fluid in the first oil tank, which may also cause damage of the second oil tank and leakage.

### SUMMARY

Therefore, an object of the disclosure is to provide a pressure relief valve device that can alleviate at least one of the drawbacks of the prior art.

According to the disclosure, a pressure relief valve device includes a valve housing, a sleeve, a pushed unit, and a biasing member. The valve housing surrounds an axis, defines a chamber therein, and has at least one exhaust opening in fluid communication with the chamber. The sleeve is connected to one end of the valve housing, and has a peripheral wall and a plurality of inlet holes. The peripheral wall surrounds the axis and defines a pressure relief hole therein. The inlet holes are formed through the peripheral wall and are in fluid communication with the pressure relief hole. The pushed unit includes a pushed rod, a flow guiding passage, and a valve cover. The pushed rod is disposed movably in the sleeve, is adapted to be pushed to move along the axis relative to the sleeve by a fluid flowing in the pressure relief hole, and blocks the fluid communication among the inlet holes and the pressure relief hole when being pushed by the fluid. The flow guiding passage extends through the pushed rod along the axis and is in fluid communication with the pressure relief hole. The valve cover is disposed in the chamber. The biasing member is disposed in the chamber and biases the valve cover toward the pushed rod. The valve cover is movable relative to the pushed rod between a closed position, where the biasing member biases the valve cover to abut against the pushed rod such that the chamber is not in fluid communication with the flow guiding passage, and a pressure relief position, where the valve cover is moved away from the pushed rod such that the flow guiding passage is in fluid communication with the chamber.

### BRIEF DESCRIPTION OF THE DRAWINGS

Other features and advantages of the disclosure will become apparent in the following detailed description of the embodiment(s) with reference to the accompanying drawings. It is noted that various features may not be drawn to scale.

FIG. 1 is a sectional view of a conventional pressure relief valve, illustrating a pushed rod of the conventional pressure relief valve being at a communication position relative to a sleeve.

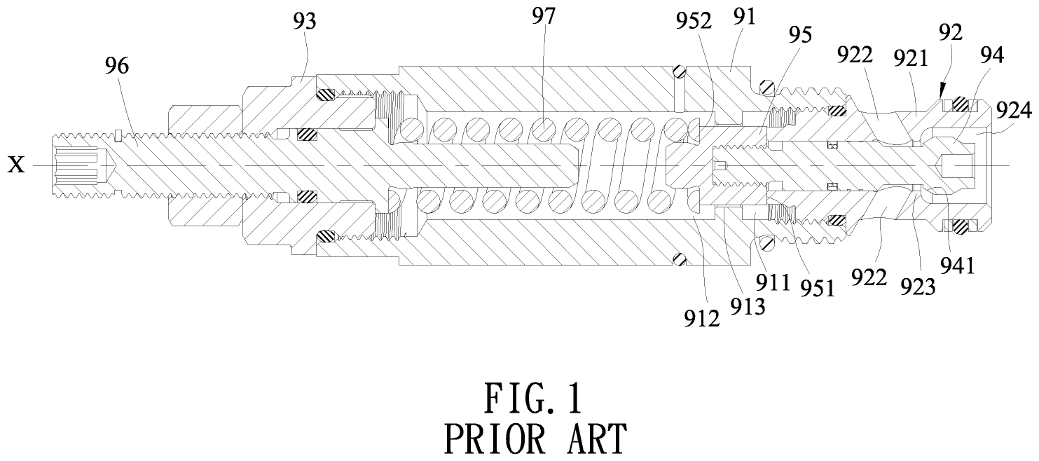

FIG. 2 is another sectional view of the conventional pressure relief valve, illustrating the pushed rod being at a closed position relative to the sleeve.

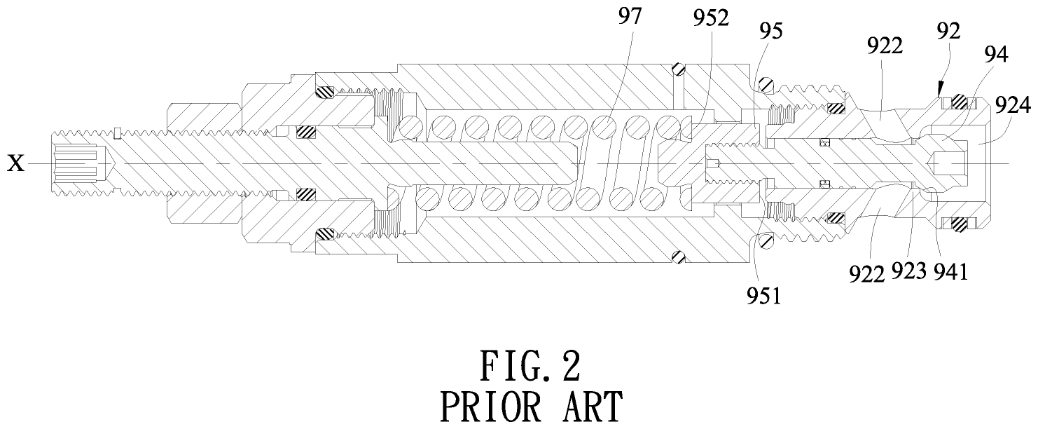

FIG. 3 is a sectional view of a pressure relief valve device of an embodiment according to the present disclosure being inserted into a valve block.

FIG. 4 is a sectional view similar to FIG. 3 but illustrating a valve cover of the pressure relief valve device being at a closed position and abutting against a pushed rod of the pressure relief valve device.

FIG. 5 is a fragmentary enlarged sectional view of FIG. 4;

FIG. 6 is a sectional view of the embodiment, illustrating the valve cover being at a pressure relief position and spaced apart from the pushed rod.

FIG. 7 is a fragmentary enlarged sectional view of FIG. 6.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

It should be noted herein that for clarity of description, spatially relative terms such as “top,” “bottom,” “upper,” “lower,” “on,” “above,” “over,” “downwardly,” “upwardly” and the like may be used throughout the disclosure while making reference to the features as illustrated in the drawings. The features may be oriented differently e.g., rotated 90 degrees or at other orientations and the spatially relative terms used herein may be interpreted accordingly.

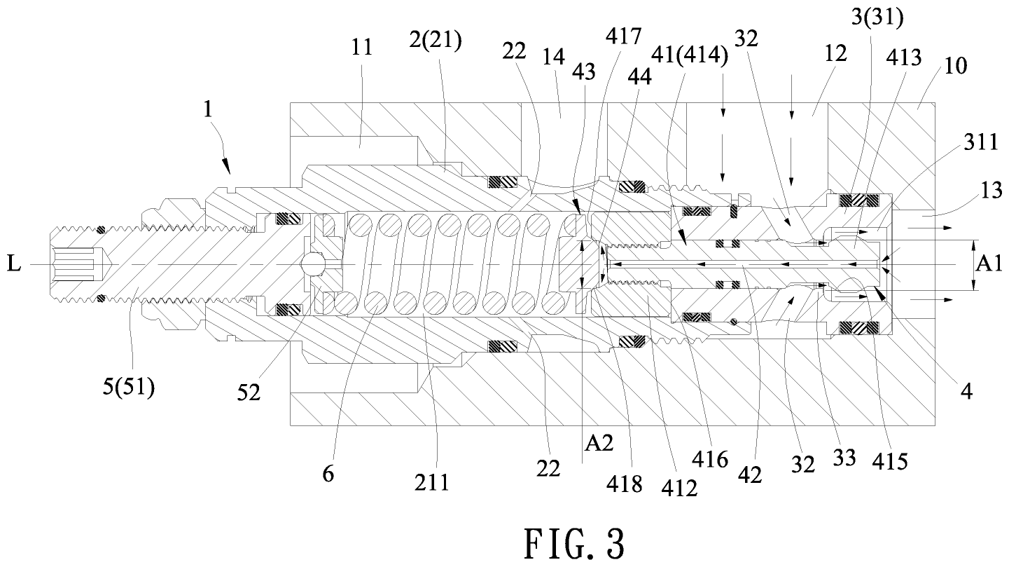

Referring to FIG. 3, a pressure relief valve device 1 of an embodiment according to the present disclosure is adapted to be mounted on a valve block 10. The valve block 10 has an insertion slot 11 for insertion of the pressure relief valve device 1 therein, a first oil inlet 12 in fluid communication with the insertion slot 11, a second oil inlet 13 in fluid communication with the insertion slot 11, and a third oil inlet 14 in fluid communication with the insertion slot 11. The first oil inlet 12 is in fluid communication with a first oil tank (not shown). The second oil inlet 13 is in fluid communication with a second oil tank (not shown). The third oil inlet 14 is in fluid communication with a recycling oil tank (not shown). The pressure relief valve device 1 includes a valve housing 2, a sleeve 3, a pushed unit 4, a pressure setting unit 5, and a biasing member 6.

The valve housing 2 includes a housing body 21 surrounding an axis (L) and defining a chamber 211, and a plurality of exhaust openings 22 formed through the housing body 21. The exhaust openings 22 are in fluid communication with the chamber 211 and the third oil inlet 14. In other embodiments, a number of the exhaust opening 22 may be one.

The sleeve 3 has a peripheral wall 31, a plurality of inlet holes 32, and a first shoulder 33. The peripheral wall 31 is connected to one end of the housing body 21, surrounds the axis (L), and defines a pressure relief hole 311 therein, and the pressure relief hole 311 is in fluid communication with the second oil inlet 13. The inlet holes 32 are formed through the peripheral wall 31 and are in fluid communication with the first oil inlet 12 and the pressure relief hole 311. The first shoulder 33 extends inwardly from an inner surface of the peripheral wall 31, surrounds the axis (L), is disposed between the inlet holes 32 and the pressure relief hole 311 along the axis (L), and has a first caliber smaller than a caliber of the pressure relief hole 311.

The pushed unit 4 includes a pushed rod 41 disposed movably in the sleeve 3, a flow guiding passage 42 extending through the pushed rod 41 along the axis (L) and in fluid communication with the pressure relief hole 311, a valve cover 43 disposed in the chamber 211, and a pressure relief passage 44 formed between the pushed rod 41 and the valve cover 43.

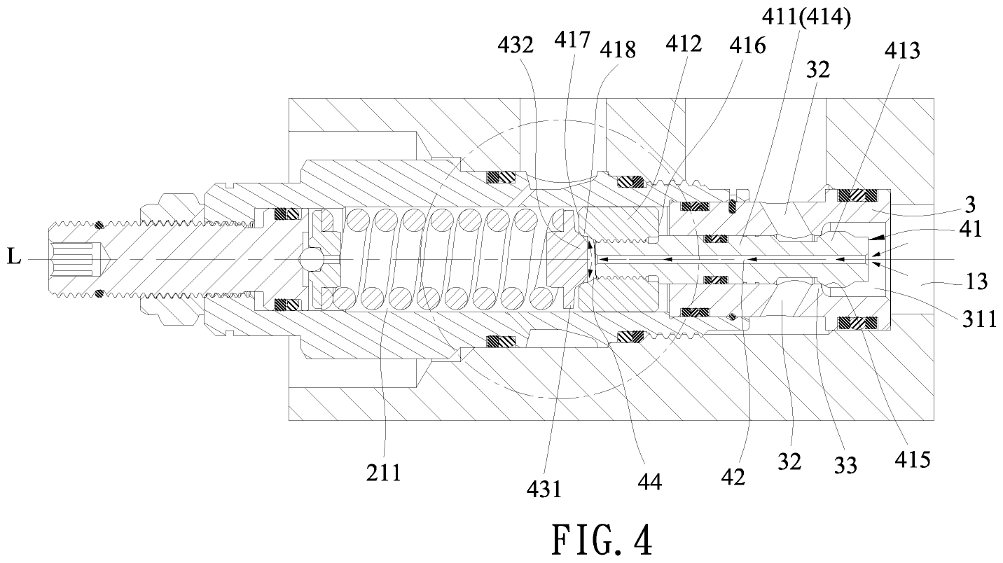

Referring to FIGS. 3 and 4, the pushed rod 41 includes a rod member 411 extending into the sleeve 3 and movable along the axis (L), and a stopping member 412 connected to the rod member 411, disposed in the chamber 211, and having one end that abuts against the sleeve 3 and another end that has a second shoulder 418. The rod member 411 has a head portion 413 disposed in the pressure relief hole 311, a body portion 414 having one end that is opposite to the head portion 413 and that extends outwardly of the peripheral wall 31, and an opposite end that is connected to the head portion 413 and that has a diameter perpendicular to the axis (L) and smaller than a diameter of the head portion 413, and an inclined surface 415 formed on the head portion 413. It should be noted that the inclined surface 415 is not limited to a level surface shown in the drawings, and may be an arc-shaped surface. The stopping member 412 is hollowed, is sleeved on and threadedly engages the end of the body portion 414 opposite to the head portion 413, and is co-movable with the rod member 411 along the axis (L). The stopping member 412 has a first stop end portion 416 disposed adjacent to the sleeve 3 and a second stop end portion 417 opposite to the first stop end portion 416 along the axis (L). The second shoulder 418 is formed on the second stop end portion 417, is disposed adjacent to the valve cover 43, and surrounds the axis (L). In this embodiment, the second shoulder 418 is a projection extending from an inner surface of the stopping member 412 toward the axis (L).

The first shoulder 33 defines a first hole dimension (A1) surrounding the axis (L) larger than a second hole dimension (A2) defined by the second shoulder 418 and surrounding the axis (L).

The flow guiding passage 42 extends through the head portion 413 and the body portion 414 along the axis (L) and is in fluid communication with the pressure relief hole 311 and thus the second oil inlet 13.

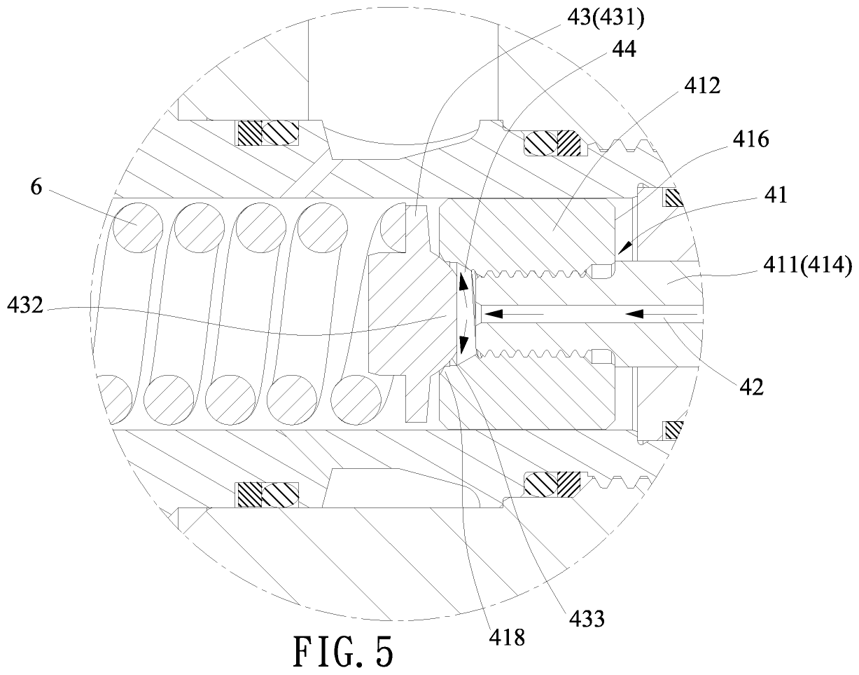

Referring to FIGS. 4 and 5, the valve cover 43 includes an annular flange portion 431 abutting against the biasing member 6, and a projecting stud 432 extending from the annular flange portion 431 along the axis (L) and operable to abut against the stopping member 412. In this embodiment, the projecting stud 432 is disposed adjacent to the stopping member 412, and has a curved surface 433 facing the stopping member 412. It should be noted that the curved surface 433 is not limited to an arc-shaped surface shown in the drawing, and may be a level surface in other embodiments of the present disclosure.

The pressure relief passage 44 is defined among the body portion 414 of the rod member 411, the second shoulder 418 of the stopping member 412, and the curved surface 433 of the valve cover 43. The pressure relief passage 44 is in fluid communication with one end of the flow guiding passage 42 that is opposite to the pressure relief hole 311 along the axis (L).

It should be noted that in this embodiment, the pushed rod 41 is constituted by the rod member 411 threadedly engaging the stopping member 412. However, in other embodiments, the rod member 411 and the stopping member 412 may be formed integrally as one piece, and is not limited to the structure disclosed herein.

Referring to FIG. 3, the pressure setting unit 5 is connected to one end of the valve housing 2 that is opposite to the sleeve 3, and includes an adjustment rod 51 that is movable along the axis (L) and that extends into the chamber 211, and a pushed cap 52 that is disposed in the chamber 211 and that is disposed between and abuts against the adjustment rod 51 and the biasing member 6. In this embodiment, the adjustment rod 51 of the pressure setting unit 5 threadedly engages the end of the valve housing 2 that is opposite to the sleeve 3, and the pushed cap 52 is connected co-movably to the adjustment rod 51.

The biasing member 6 is disposed in the chamber 211, and is disposed between and abuts against the valve cover 43 and the pushed cap 52. In this embodiment, the biasing member 6 is configured as a compression spring and biases the valve cover 43 toward the stopping member 412 of the pushed rod 41.

The adjustment rod 51 is operable to drive the pushed cap 52 to co-move therewith along the axis (L) when being rotated. When the adjustment rod 51 moves toward the valve cover 43 through threaded engagement with the housing 2, the biasing member 6 is compressed by the pushed cap 52 such that a degree of compression of the biasing member 6 is adjusted to thereby adjust a biasing force of the biasing member 6 exerted on the valve cover 43.

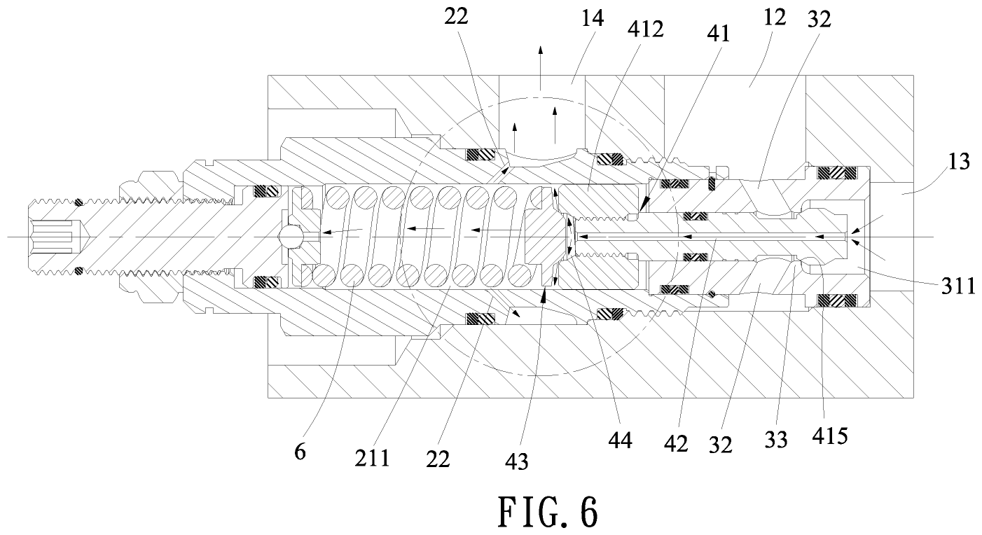

Referring to FIGS. 4 and 6, the valve cover 43 is movable relative to the pushed rod 41 between a closed position (as shown in FIG. 4) and a pressure relief position (as shown in FIG. 6). When the valve cover 43 is at the closed position, the biasing member 6 biases the valve cover 43 to abut against the pushed rod 41 such that the chamber 211 is not in fluid communication with the flow guiding passage 42. When the valve cover 43 is at the pressure relief position, the valve cover 43 is moved away from the pushed rod 41 such that the chamber 211 is in fluid communication with the flow guiding passage 42.

Specifically, as shown in FIGS. 3 to 5, the valve cover 43 is pushed by the biasing force of the biasing member 6 to abut against the pushed rod 41 when being at the closed position, and the curved surface 433 abuts against the second shoulder 418 to block the fluid communication between the chamber 211 and the flow guiding passage 42.

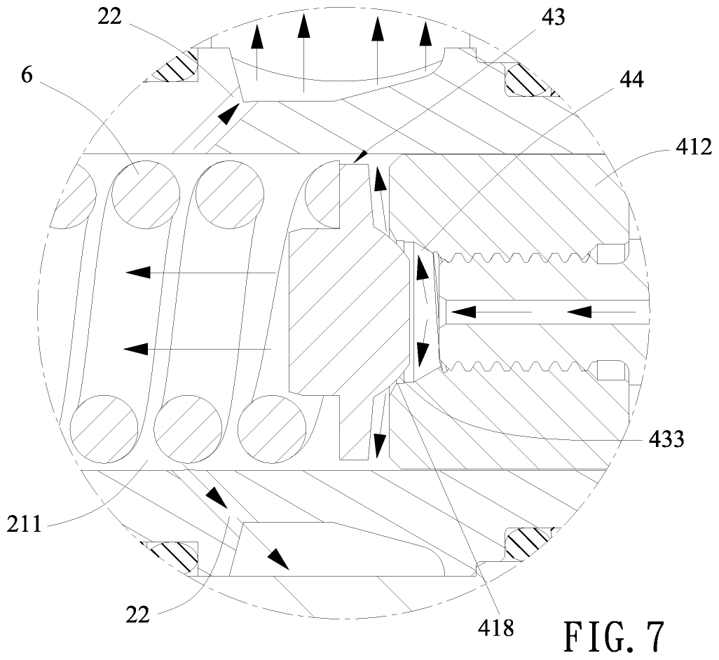

As shown in FIGS. 6 and 7, when a pushing force of the fluid in the pressure relief passage 44 is large enough to overcome the biasing force of the biasing member 6, the valve cover 43 is pushed to move in a direction away from the pushed rod 41 to the pressure relief position, so a gap is formed between the second shoulder 418 and the curved surface 433. At this position, the curved surface 433 of the valve cover 43 is spaced apart from the second shoulder 418, and does not abut against the pushed rod 41, so as to allow fluid communication between the chamber 211 and the flow guiding passage 42 via the pressure relief passage 44. At this time, the fluid in the flow guiding passage 42 may flow into the chamber 211 through the pressure relief passage 44, and then discharges through the exhaust openings 22.

Referring to FIG. 3, in a case where a pressure of a fluid (such as a hydraulic oil) in the first oil tank is larger than a predetermined threshold, the fluid in the first oil tank flows from the first oil inlet 12 through the inlet holes 32 into the pressure relief hole 311, and then flows into the second oil tank through the second oil inlet 13 to reduce the pressure of the fluid in the first oil tank. The fluid in the pressure relief hole 311 also flows through the flow guiding passage 42 into the pressure relief passage 44. At the position shown in FIG. 3, a pushing force of the fluid in the second oil tank and the pressure relief hole 311 is smaller than the biasing force of the biasing member 6, so the pushed rod 41 remains still and does not move along the axis (L), and the valve cover 43 also remains at the closed position.

The pushed rod 41 is adapted to be pushed to move along the axis (L) relative to the sleeve 3 by the fluid in the second oil tank, the second oil inlet 13, and the pressure relief hole 311 so as to counteract the biasing force of the biasing member 6 and to block fluid communication among the inlet holes 32 and the pressure relief hole 311. Referring to FIGS. 4 and 5, in a case where the pressures of the fluid in the second oil tank, the second oil inlet 13, and the pressure relief hole 311 are gradually increased to be larger than the biasing force of the biasing member 6, the pushed rod 41 is pushed by the fluid to drive the valve cover 43 to move toward the pushed cap 52 along the axis (L) and compresses the biasing member 6 until the inclined surface 415 engages and abuts against the first shoulder 33. Since the inlet holes 32 are not in fluid communication with the pressure relief hole 311 at this position, the fluid in the first oil tank is prevented from flowing from the inlet holes 32 into the pressure relief hole 311, i.e., the fluid in the first oil tank no longer flows to the second oil tank, and the pushed rod 41 is no longer moved. Since the flow guiding passage 42, the pressure relief passage 44, the pressure relief hole 311, the second oil inlet 13, and the second oil tank are in fluid communication with one another, the pressures of the fluid therein are the same. When a pushing force of the pressure of the fluid in the pressure relief passage 44 is smaller than or equal to the biasing force of the biasing member 6, the valve cover 43 remains at the closed position, the projecting stud 432 abuts against the stopping member 412, and the curved surface 433 abuts against the second shoulder 418 to close the pressure relief passage 44.

Referring to FIGS. 6 and 7, in a case where the pressure of fluid in the second oil tank undesirably increases, for example, when an ambient temperature rises and a volume of the fluid expands, or when the inclined surface 415 and the first shoulder 33 are worn and cannot sealingly block the fluid communication among the inlet holes 32 and the pressure relief hole 311, the fluid in the first oil tank may continuously flow into the second oil tank. According to the pressure formula P=F/A, where P represents a pressure, F represents a magnitude of a force and A represents an area of a surface on contact, given that a sectional area (A) of the pressure relief passage 44 is constant, a pushing force (F) of the fluid in the pressure relief passage 44 exerted on the valve cover 43 is in positive correlation to a pressure (P) of the fluid in the pressure relief passage 44. That is, when the pressure (P) of the fluid in the pressure relief passage 44 is increased, the pushing force (F) of the fluid in the pressure relief passage 44 applied to the valve cover 43 is also increased. When the pushing force (F) is greater than the biasing force provided by the biasing member 6 to the valve cover 43, the fluid in the pressure relief passage 44 pushes the valve cover 43 to move away from the stopping member 412, and a gap is formed between the second shoulder 418 and the curved surface 433, so that the valve cover 43 is moved to the pressure relief position, thereby opening the pressure relief passage 44 to allow the fluid communication of the chamber 211 and the flow guiding passage 42. At this position, the fluid in the second oil tank flows through the flow guiding passage 42 and the pressure relief passage 44 into the chamber 211, and then flows through the exhaust openings 22 and the third oil inlet 14 into the recycling oil tank to complete a pressure relief function for the second oil tank, thereby preventing damage of the second oil tank and leakage of the fluid.

It should be noted that by virtue of the first hole dimension (A1) of the first shoulder 33 being larger than the second hole dimension (A2) of the second shoulder 418, the pushed rod 41 is first moved by the fluid, so the inclined surface 415 engages and presses against the first shoulder 33, and then the fluid sequentially flows through the flow guiding passage 42 to push the valve cover 43 so as to open the pressure relief passage 44. When the inclined surface 415 is spaced apart from the first shoulder 33, the inlet holes 32 and the pressure relief hole 311 are still in fluid communication with one another, and the pressures of the fluid in the pressure relief hole 311, the flow guiding passage 42, and the pressure relief passage 44 are the same. According to the pressure formula P=F/A, a pushing force (F) of the fluid exerted on the valve cover 43 and the pushed rod 41 is a product of the pressure (P) and a sectional area (A) of a passage, through which the fluid flows. Specifically, a pushing force (F1) of the fluid provided to the pushed rod 41 is a product of the pressure (P) of the fluid in the pressure relief hole 311 and the first hole dimension (A1) defined by the first shoulder 33, i.e., F1=P×A1. Similarly, a pushing force (F2) of the fluid provided to the valve cover 43 is a product of the pressure (P) of the fluid in the pressure relief passage 44 and the second hole dimension (A2) defined by the second shoulder 418, i.e., F2=P×A2. Since the pressures of the fluid in the pressure relief hole 311, the flow guiding passage 42, and the pressure relief passage 44 are the same, and since the first hole dimension (A1) defined by the first shoulder 33 is larger than the second hole dimension (A2) defined by the second shoulder 418, the pushing force (F1) exerted on the pushed rod 41 is larger than the pushing force (F2) exerted on the valve cover 43. In this way, the pushed rod 41 is first moved to drive movement of the valve cover 43 to compress the biasing member 6 until the inclined surface 415 engages and abuts against the first shoulder 33. That is to say, the valve cover 43 does not move relative to the stopping member 412 prior to movement of the pushed rod 41, and the pressure relief passage 44 would not be opened prior to the inclined surface 415 engaging the first shoulder 33.

In a case where the first hole dimension (A1) of the first shoulder 33 is smaller than the second hole dimension (A2) of the second shoulder 418, the valve cover 43 is moved away from the stopping member 412 to open the pressure relief passage 44 prior to the inclined surface 415 abutting against the first shoulder 33. Consequently, the fluid from the first oil tank continuously flows through the pressure relief hole 311, the flow guiding passage 42 and the pressure relief passage 44 into the chamber 211, and then flows into the recycling oil tank through the exhaust openings 22 via the third oil inlet 14, which may excessively allow the pressure of fluid in the first oil tank to be lower than an expected value.

In summary, in the pressure relief valve device 1 of the present disclosure, by virtue of the flow guiding passage 42 being formed through the pushed rod 41, and the pressure relief passage 44 being formed between the pushed rod 41 and the valve cover 43, after the inclined surface 415 abuts against the first shoulder 33 to block the fluid communication among the inlet holes 32 and the pressure relief hole 311, and when the pressure of the fluid in the second oil tank continuously increases, the pushing force of the fluid in the pressure relief passage 44 is increased to be larger than the biasing force of the biasing member 6 exerted on the valve cover 43, so that the valve cover 43 is moved away from the stopping member 412 to the pressure relief position. Thus, the fluid in the second oil tank flows into the chamber 211 through the flow guiding passage 42 and the pressure relief passage 44 and then flows through the exhaust openings 22 into the recycling oil tank to complete pressure relief to the second oil tank.

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects; such does not mean that every one of these features needs to be practiced with the presence of all the other features. In other words, in any described embodiment, when implementation of one or more features or specific details does not affect implementation of another one or more features or specific details, said one or more features may be singled out and practiced alone without said another one or more features or specific details. It should be further noted that one or more features or specific details from one embodiment may be practiced together with one or more features or specific details from another embodiment, where appropriate, in the practice of the disclosure.

While the disclosure has been described in connection with what is (are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. A pressure relief valve device comprising:
a valve housing that surrounds an axis, that defines a chamber therein, and that has at least one exhaust opening in fluid communication with said chamber;
a sleeve that is connected to one end of said valve housing, and that has
a peripheral wall surrounding the axis and defining a pressure relief hole therein, and
a plurality of inlet holes formed through said peripheral wall and in fluid communication with said pressure relief hole;
a pushed unit that includes
a pushed rod disposed movably in said sleeve, adapted to be pushed to move along the axis relative to said sleeve by a fluid flowing in said pressure relief hole, and blocking the fluid communication among said inlet holes and said pressure relief hole when being pushed by the fluid,
a flow guiding passage extending through said pushed rod along the axis and in fluid communication with said pressure relief hole, and
a valve cover disposed in said chamber; and
a biasing member that is disposed in said chamber and that biases said valve cover toward said pushed rod;
wherein said valve cover is movable relative to said pushed rod between a closed position, where said biasing member biases said valve cover to abut against said pushed rod such that said chamber is not in fluid communication with said flow guiding passage, and a pressure relief position, where said valve cover is moved away from said pushed rod such that said flow guiding passage is in fluid communication with said chamber.

2. The pressure relief valve device as claimed in claim 1, wherein:
said sleeve further has a first shoulder extending inwardly from an inner surface of said peripheral wall and surrounding the axis, and disposed between said inlet holes and said pressure relief hole; and
said pushed rod has an inclined surface engaging and pressing against said first shoulder to block the fluid communication among said inlet holes and said pressure relief hole when being pushed by the fluid in said pressure relief hole to move relative to said sleeve.

3. The pressure relief valve device as claimed in claim 2, wherein:
said pushed unit further includes a pressure relief passage formed between said pushed rod and said valve cover, and in fluid communication with one end of said flow guiding passage that is opposite to said pressure relief hole along the axis;
said pushed rod further has a second shoulder formed adjacent to said valve cover and surrounding the axis; and
said valve cover has a curved surface abutting against said second shoulder when being at the closed position to block the fluid communication between said flow guiding passage and said chamber, and spaced apart from said second shoulder when being at the pressure relief position to allow the fluid communication between said flow guiding passage and said chamber.

4. The pressure relief valve device as claimed in claim 3, wherein said first shoulder defines a first hole dimension surrounding the axis and being larger than a second hole dimension defined by said second shoulder and surrounding the axis.

5. The pressure relief valve device as claimed in claim 3, wherein:
said pushed rod includes
a rod member extending into said sleeve, being movable along the axis, and having
a head portion that is disposed in said pressure relief hole,
a body portion that has one end extending outwardly of said peripheral wall and an opposite end connected to said head portion and having a diameter perpendicular to the axis and smaller than a diameter of said head portion, and
said inclined surface that is formed on said head portion, and
a stopping member connected to said rod member, disposed in said chamber, and having one end that abuts against said sleeve and another end that has said second shoulder; and
said flow guiding passage extends through said head portion and said body portion along the axis.

6. The pressure relief valve device as claimed in claim 5, wherein said valve cover includes
an annular flange portion abutting against said biasing member, and
a projecting stud extending from said annular flange portion along the axis, being operable to abut against said stopping member, and having said curved surface.

7. The pressure relief valve device as claimed in claim 1, wherein:
said pressure relief valve device further comprises a pressure setting unit that is connected to an end of said valve housing opposite to said sleeve, and that includes
an adjustment rod movable along the axis and extending into said chamber, and
a pushed cap disposed between and abutting against said adjustment rod and said biasing member; and
said biasing member is compressed by said pushed cap when said adjustment rod moves along the axis such that a degree of compression of said biasing member is adjusted to thereby adjust a biasing force of said biasing member exerted on said valve cover.
